(19) United States
(12) Patent Application Publication
(10) Pub. No.: US 2022/0262278 A1
(43) Pub. Date: Aug. 18, 2022

(54) System For Stacking Pre-Shaped Signage Components

(71) Applicant: Yardlio Pty Ltd., Elizabeth Bay NSW (AU)

(72) Inventor: David Morgan STOCKLEY, Elizabeth Bay (AU)

(73) Assignee: Yardlio Pty Ltd., Elizabeth Bay NSW (AU)

(21) Appl. No.: 17/673,184

(22) Filed: Feb. 16, 2022

Related U.S. Application Data
(60) Provisional application No. 63/149,679, filed on Feb. 16, 2021.

(51) Int. Cl. G09F 7/18

(52) U.S. Cl. CPC G09F 7/18; G09F 2007/1804

(57) ABSTRACT

The herein disclosed invention pertains to a system for stacking pre-shaped signage components into a multi-level single message configuration. The signage components have vertical flutes alignable with vertical flutes in a contiguous signage component, and the signage components also have markings to facilitate alignment with the contiguous signage component. Connecting elements fit into the vertical flutes in contiguous vertical signage components to secure the signage components together. This allows the contiguous vertical signage components to align, thereby creating an image of the multi-level message.

### FIELD OF THE INVENTION

This invention pertains to the outdoor landscaping field, and, in particular, to the creation of multi-level outdoor messages.

### BACKGROUND OF THE INVENTION

The herein disclosed invention is a unique ‘stacking’ system for outdoor signage. According to the known techniques and methods, this type of sign is printed on corrugated plastic and installed using straight, kinked or H shaped ‘stakes’ made from plastic, timber or steel. The stakes insert into the ‘flutes’ (vertical hollows) in the plastic to hold them in place. The problem with this kind of system is that signs/shapes/letters are all on a single level and, so visually, one sign will often block the view to another sign behind it.

Accordingly, there is a need in the industry and field for a system that can efficiently and effectively provide a stacking system for outdoor signs that permits all the sign components to be easily seen.

### SUMMARY OF THE INVENTION

To achieve these and other objects, the herein system constitutes a stacking design, thereby allowing the sign to be built in multiple-levels for increased visibility.

In a basic embodiment, the Invention constitutes a system for stacking pre-shaped signage components into a multi-level single message configuration: the signage components having vertical flutes alignable with vertical flutes in a contiguous signage component, and the signage components having markings to facilitate alignment with said contiguous signage component; and connecting elements fitting into vertical flutes in contiguous vertical signage components to secure the signage components together, wherein the contiguous vertical signage components thereby aligning to create an image of the multi-level message.

The signs/shapes/letters are typeset in a strategic way to align vertical flutes. Markers are positioned in the design for end user to align shapes to build the levels.

Various sized H-Stakes and Rods connect one level with another level, such that the typesetting remains in alignment.

The position and length of these stakes also provides additional support/stability.

Such a system provides versatility, so, for example, it can be built 1, 2 or 3 levels high.

Therefore, to achieve these and other objects, the herein disclosed invention is a system for stacking pre-shaped signage components into a multi-level single message configuration, wherein the contiguous vertical signage components align to create an image of the multi-level message.

### BRIEF DESCRIPTION OF THE FIGURES

For a better understanding of the invention and to show how it may be carried into effect, reference will now be made, purely by way of example, to the accompanying Figures, wherewith it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

FIGS. 1a, 1b, 1c, 1d and 1e are perspective views of different connectors.

FIGS. 2a, 2b, 2c and 2d are drawings, showing the manner in which the pieces of the system are assembled to create a final multi-level image.

FIGS. 3a is an enlarged view to show the connection of the components and the connectors, and FIG. 3b is an enlarged view of the area A shown in FIG. 3a.

FIGS. 3c and 3d show other images that can be created with the invention.

FIG. 4 shows the signs/shapes/letters are typeset in a strategic way to align vertical flutes. The Markers are positioned in the design for end user to align shapes to build the levels.

FIG. 5 shows the various sized H-Stakes and Rods connect one level with another level, such that the typesetting remains in alignment.

FIG. 6 shows the position and length of these stakes also provides additional support/stability.

FIG. 7 shows the guidelines are printed at predetermined positions on each segment.

FIG. 8 shows the connectors are inserted at the guidelines.

FIG. 9 shows the segments are ‘stacked’ vertically using connectors at guidelines.

FIG. 10 shows the segments are ‘stacked’ vertically using connectors at guidelines.

FIG. 11 shows a segment to utilize straight rods as connectors.

FIG. 12 show the finished multi-level sign is installed in the ground.

FIG. 13 shows how a single numeral can be created. The figure is divided into segments which are cut from corrugated sheets.

FIG. 14 shows the Straight & H-Shaped rods are inserted into the corrugations at predetermined positions.

FIG. 15 shows the segments are aligned using printed guidelines and connected together.

FIG. 16 shows the segments are connected to form the visually recognizable image.

FIG. 17 shows the additional connectors are inserted for structural support and to stand the sign in place.

FIG. 18 shows the finished multi-level sign upright in the ground.

FIG. 19 shows a LARGE H-Stake.

FIG. 20 shows the H-Stake posts into the plastic until the crossbar is 1″ from the bottom of the letter.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In a basic embodiment, the Invention constitutes a system for stacking pre-shaped signage components into a multi-level single message configuration: the signage components having vertical flutes alignable with vertical flutes in a contiguous signage component, and the signage components having markings to facilitate alignment with said contiguous signage component; and connecting elements fitting into vertical flutes in contiguous vertical signage components to secure the signage components together, wherein the contiguous vertical signage components thereby aligning to create an image of the multi-level message.

According to preferred embodiments the term “message” necessarily includes single word and multi word messages, logos, designs, symbols, letters, numbers, pictures, images and any graphical image.

Preferably, the image of a single message is divided into component images appearing as design components appearing on said signage components.

The invention contemplates that desired images, messages and shapes are designed and cut in a ‘jigsaw puzzle’ type manner to create the individual signage components. In other words, a portion of the final image or message is on each signage component. When all the signage components are properly mounted and aligned, the final intended image or message is created and visible. As shown in the drawings one example is Happy Birthday.

In the preferred embodiments, the connecting elements being of multiple sizes, lengths, widths, and shapes. Hence, as hereinafter described, the herein inventive system uses alignment markings and H-stakes and vertical Rods for stability when erected as a multi-level message.

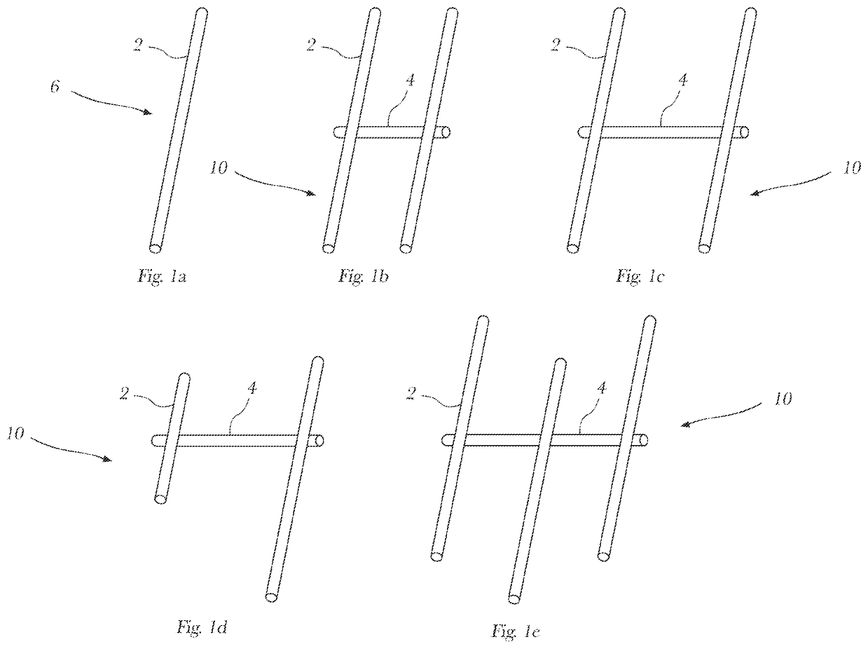

FIGS. 1a, 1b, 1c, 1d and 1e are perspective views of different connectors. As shown, FIG. 1a shows a straight connector 6, generally made as an elongated rod. Various sized H shaped connectors 10 are also used. The H-shaped connectors have one or more vertical bars 4. Though the drawings show only one horizontal bar 2 for each H connector, in some embodiments 2 or even more horizontal bars may be used. As shown, you can have a narrow H connector (FIG. 1b) or a wide H connector (FIG. 1c). Sometimes you may need an H connector where the vertical bars 4 are of different lengths (FIG. 1d), and at times more than two vertical bars 4 may be needed (FIG. 1e).

According to preferred embodiments, the vertical and horizontal rods are made of sturdy plastic or lightweight metal such as steel or aluminum. Generally, a round profile works best, but any shape may be used. As described herein afterwards, the circular diameter rods and H-stakes are sized precisely for fitting into the flutes. The widths of the H are exactly the width of the flute holes per the alignment markings for each shape. By means of a friction fit, the connectors remain in alignment and stay connected to the signage components. Usually a friction fit is adequate, but there may be embodiments where it may be advantageous to thread the end of the rods to get a more secure fitting.

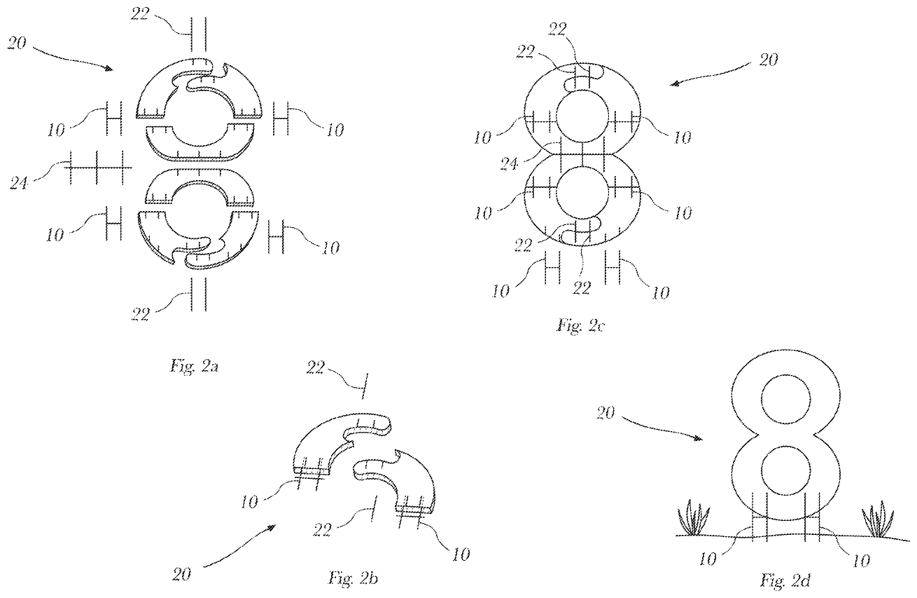

FIGS. 2a, 2b, 2c and 2c are drawings, showing the manner in which the pieces of the system are assembled to create a final multi-level image. In this example, the numeral 8 is assembled and erected.

As shown the numeral 8 is constructed of multiple fragments or components 20, each of which has a portion of the 8 imprinted on it. When all the components are assembled and aligned, the image of the 8 is clearly seen.

To start, contiguous components are connected. As illustrated in FIG. 2, connecting rods 22 and H connectors 10 are inserted into the flutes or openings of the various components. This is done for all the components and connectors (FIG. 2a). Thereafter, the components are urged together to create the final image of the numeral 8 (FIG. 2c). Thereafter, H connectors are used to support the completed image in the ground (FIG. 2d).

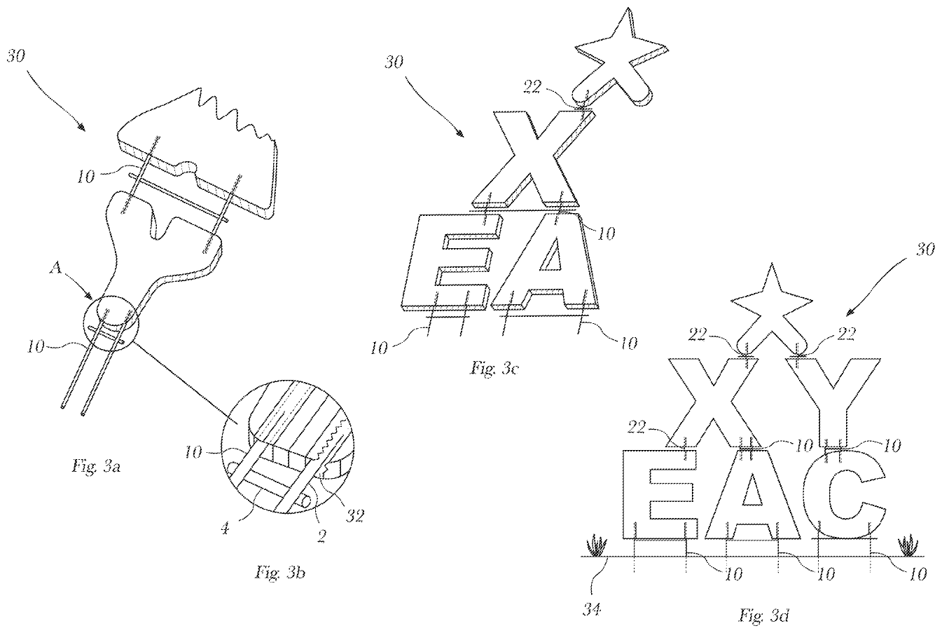

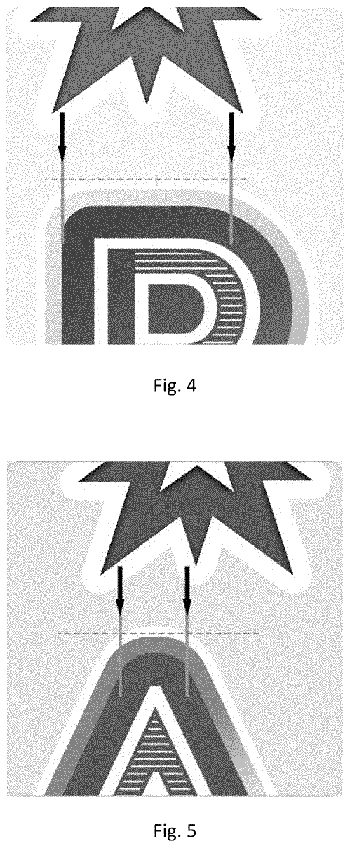

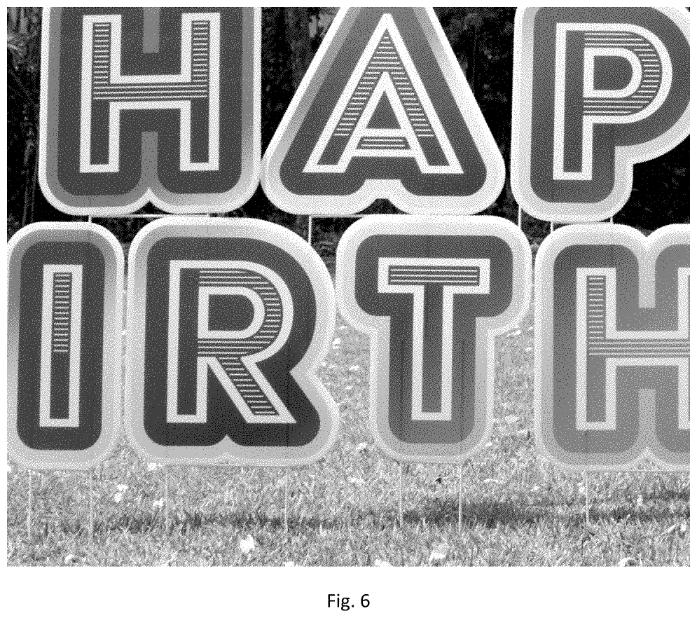

FIG. 3a is an enlarged view to show the connection of the components and the connectors, and FIG. 3b is an enlarged view of the area A shown in FIG. 3a.

According to the invention, the vertical legs or bars 2 of the H Connectors 10 (or the connecting rods themselves) fit into the flutes 32 of the design components. Necessarily the flutes are hollow so as to receive the rods. The widths of the H are exactly the width of the flute holes per the alignment markings for each shape. Further, the diameter and shape of the flutes matches the diameter and shape of the vertical legs or bars of the H connector in order to create a friction fit to hold the components and connectors securely together.

FIGS. 3c and 3d show other images that can be created with the invention from various design components 30. N such manner different letters or shapes (such as a star) can be created.

The herein disclosed system allows stacking of multiple pieces in levels, in order to build a large sign out of parts contained in a smaller shipping box. Artwork (Shapes, Numbers, Typography, Logos, etc) are designed in such a way that the image is divided into numerous segments—much like a jigsaw puzzle—which are then reconnected using rods inserted at predetermined join-points. The image is printed onto corrugated sheets of plastic or cardboard and segments are cut from the sheet.

Straight, cylindrical rods and H-Shaped connectors of the same diameter as the corrugations/flute holes are inserted at specific join-points on each segment (designated by grey printed guidelines) to connect the segments together to re-form the visual image. The connectors are manufactured at specific lengths (straight) and widths (H-Shaped) to join the pieces at the join-points.

A typical H shaped connector can be narrow or wide.

Following, illustrative examples are described.

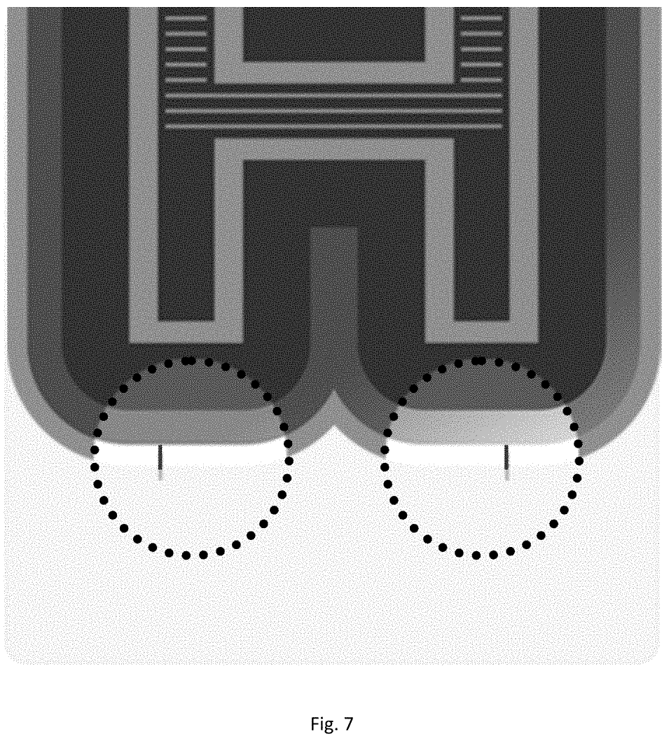

Guidelines are printed at predetermined positions on each segment (FIG. 7).

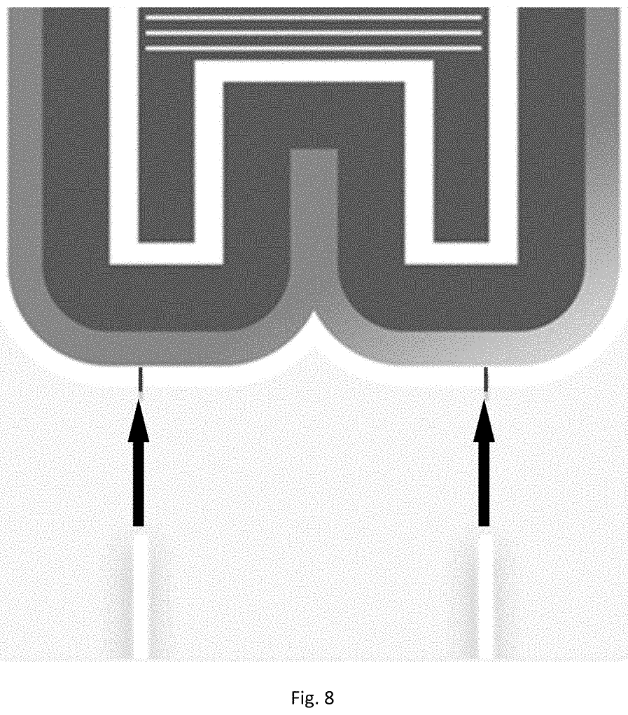

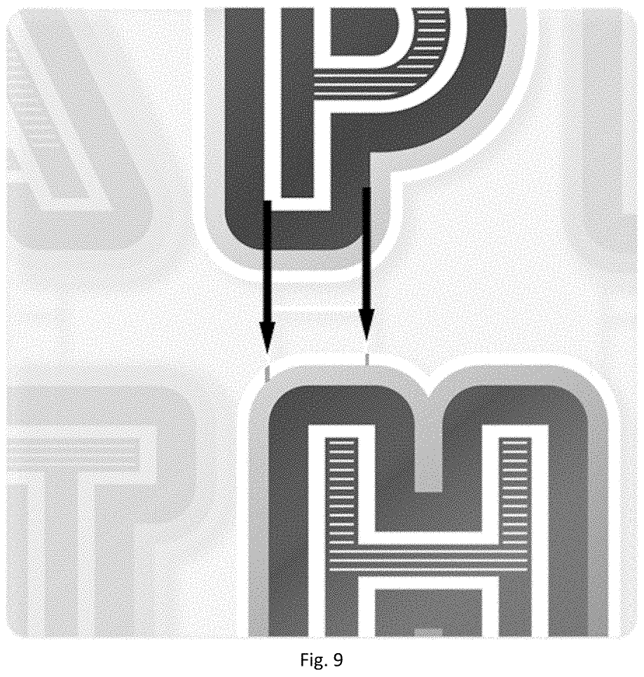

Connectors are inserted at the guidelines (FIG. 8).

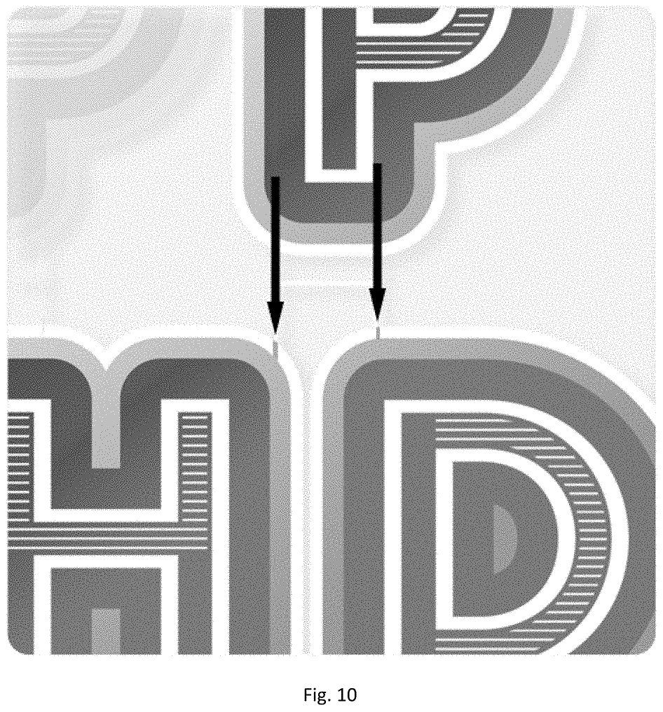

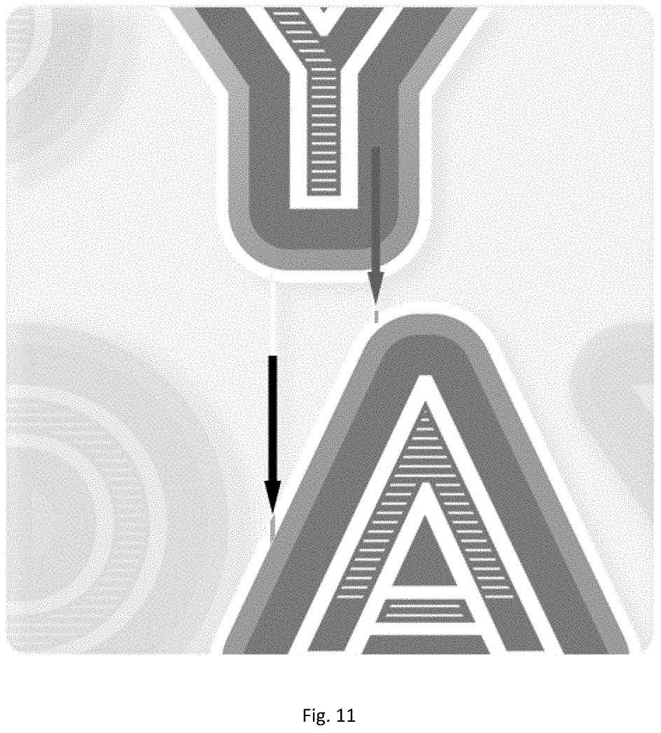

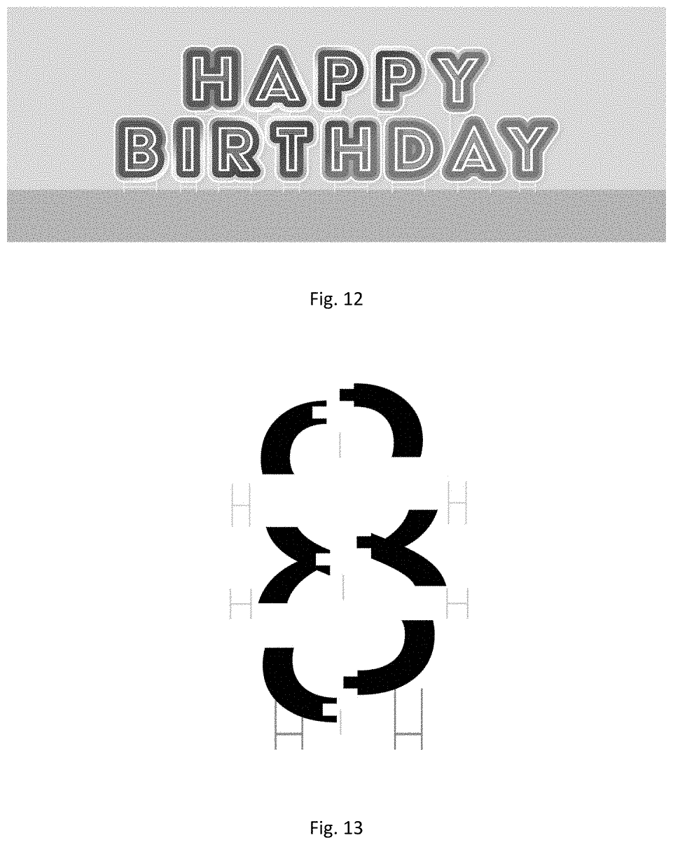

Segments are ‘stacked’ vertically using connectors at guidelines (FIGS. 9 and 10).

Some segments utilize straight rods as connectors (FIG. 11).

The finished multi-level sign is installed in the ground (FIG. 12).

Example 2 shows how a single numeral can be created (FIG. 13).

The image is divided into segments which are cut from corrugated sheets (FIG. 13).

Straight & H-Shaped rods are inserted into the corrugations at predetermined positions (FIG. 14).

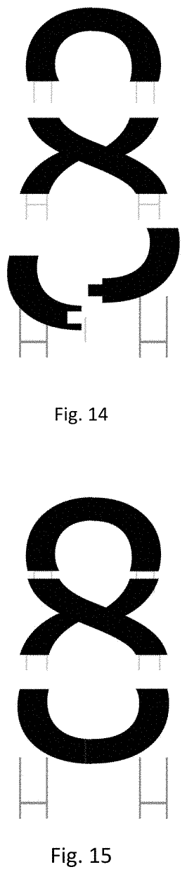

The segments are aligned using printed guidelines and connected together (FIG. 15).

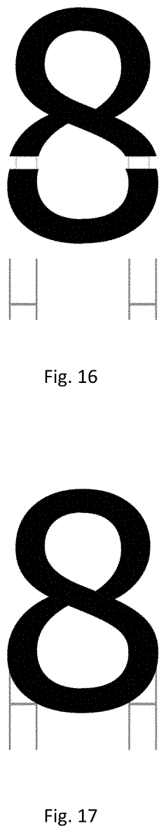

Once connected, the segments form the visually recognizable image (FIG. 16).

Additional connectors are inserted for structural support and to stand the sign in place (FIG. 17).

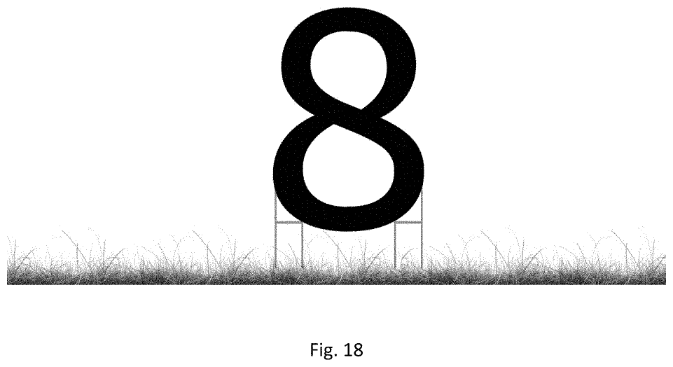

The finished multi-level sign upright in the ground (FIG. 18).

In a preferred illustrative embodiment, construction is a 3-step process. First, you will insert H-stakes into all of the letters and stars. Next, you will lay flat the parts where you want to build. Finally, you will install the letters in the ground and add new stars.

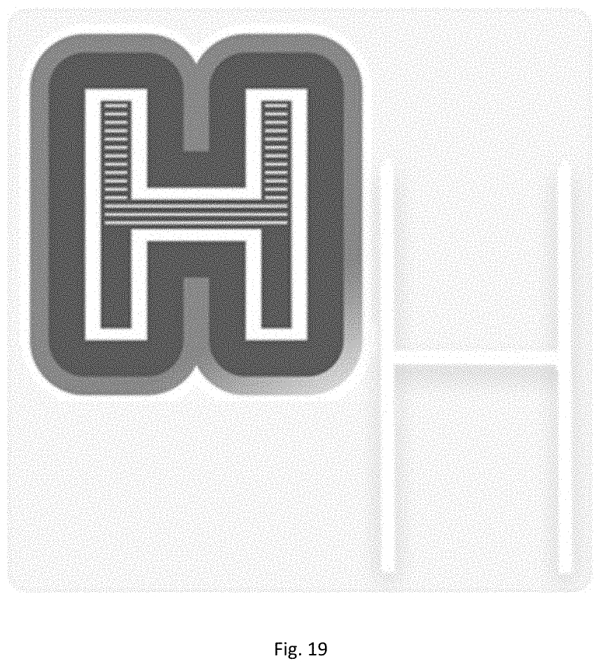

For example, Start with the first letter in the LARGE group, the PINK letter H for HAPPY. This requires a LARGE H-Stake (FIG. 19).

Position the H-Stake so the crossbar faces down and away from the printed side of the plastic.

Locate the small grey lines at the base of this PINK letter “H”

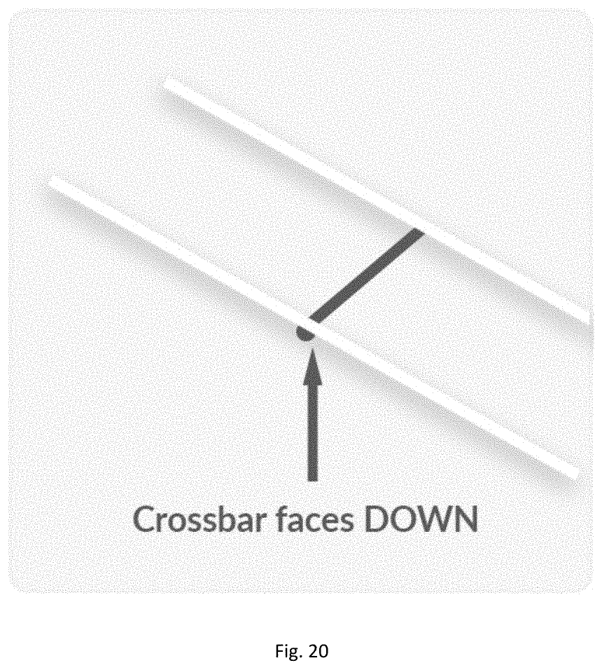

Insert the H-Stake posts into the plastic until the crossbar is 1″ from the bottom of the letter (FIG. 20).

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A system for stacking pre-shaped signage components into a multi-level single message configuration:
Said signage components having vertical flutes alignable with vertical flutes in a contiguous signage component, and said signage components having markings to facilitate alignment with said contiguous signage component; and
Connecting elements fitting into said vertical flutes in contiguous vertical signage components to secure said signage components together, wherein said contiguous vertical signage components thereby aligning to create an image of said multi-level message.

2. A system according to claim 1, wherein said connecting elements being of multiple sizes, lengths, widths, or shapes.

3. A system according to claim 1, wherein said image of single message being divided into component images appearing as design components appearing on said signage components.
